(19) United States
(12) Patent Application Publication
(10) Pub. No.: US 2008/0055698 A1
(43) Pub. Date: Mar. 6, 2008

(54) OPTICAL MODULATOR AND OPTICAL MODULATOR MODULE FOR REDUCING LASER SPECKLE

(75) Inventors: Victor Yurlov, Suwon-si (KR); Anatoliy Lapchuk, Suwon-si (KR); Jong-Hyeong Song, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon-si (KR)

(21) Appl. No.: 11/752,209

(22) Filed: May 22, 2007

(30) Foreign Application Priority Data
May 23, 2006 (KR) 10-2006-0046257
May 8, 2007 (KR) 10-2007-0044462
May 21, 2007 (KR) 10-2007-0049080

(51) Int. Cl. G02F 1/01

(52) U.S. Cl. 359/240

(57) ABSTRACT

Disclosed is an optical modulator module, including an optical modulator receiving and modulating incident lights, and outputting modulated lights as output lights, and a transparent substrate that is placed on the optical modulator, allowing the incident lights and the output lights to transmit, and that has a phase manipulating pattern formed on an area of a surface of the transparent substrate. With an optical modulator module according to an embodiment of the invention, laser speckles can be reduced.

### CROSS-REFERENCES TO RELATED APPLICATIONS

This application claims the benefit of Korean Patent Application No. 10-2006-0046257 filed with the Korean Intellectual Property Office on May 23, 2006, Korean Patent Application No. 10-2007-0044462 filed with the Korean Intellectual Property Office on May 8, 2007, and Korean Patent Application No. 10-2007-0049080 filed with the Korean Intellectual Property Office on May 21, 2007, the disclosures of which are incorporated herein by reference in their entirety.

### BACKGROUND

1. Technical Field

The present invention relates to an apparatus displaying two dimensional images by scanning one dimensional linear lights, more particularly to, a display apparatus with a phase manipulating pattern formed in an optical modulator or an optical modulator module, thereby capable of reducing laser speckles.

2. Description of the Related Art

Human eyes have finite resolution. When viewing an object, the eye quantizes an object into spots using the resolution. For example, if a viewer is 3 meters away from an object, his/her eyes recognize the object by breaking it down into spots of about 1 mm-diameter.

FIG. 1 illustrates a human eye viewing a diffusion surface. Laser beams 16 from a laser source illuminate the diffusion surface 14. A resolution spot 18 on the diffusion surface 14 is imaged onto the retina of the eye 12. However, the eye 12 cannot resolve features on the diffusion surface 14 smaller than the resolution spot 18.

The resolution spot 18 has a plurality of scattering centers, through which the laser beam 16 is scattered. Since the laser beam 16 has coherent characteristic, the scattering centers create interference to the eye 12.

This interference allows the eye 12 to perceive the resolution spot 18 in a grayscale between the brightest and the darkest. Each scattering center of the resolution spot 18 functions as a center of various light waves, each of which constructively or destructively interferes to generate the grayscale of the resolution spot 18.

For example, when the light waves constructively interfere, the resolution spot 18 becomes a bright spot, and when destructively interfere, the resolution spot 18 becomes a dark spot. Accordingly, the diffusion surface 14 is imaged onto the eye as a granular pattern that is randomly patterned with spots of from highly bright to dark. Such a granular pattern is called a speckle.

The above description is also true for an optical system. The optical system uses the same principle as the human eye 12 to detect the speckle generated on a rough surface such as the diffusion surface 14 illuminated by a laser light.

FIG. 2 illustrates a photo of a speckle where spots of various brightness are formed in a granular pattern. Such a speckle, degrading the quality of display images, should be reduced.

The speckle illustrated in FIG. 2 can be reduced by superimposing an N number of uncorrelated speckle patterns. If the N uncorrelated speckle patterns have the equal mean intensity, a speckle reduction factor can be \sqrt{N}. However, if the N uncorrelated speckle patterns have different mean intensities, the speckle reduction factor would be less than \sqrt{N}. Furthermore, the uncorrelated speckle pattern can be obtained by means of time, frequency, or polarization without spatial superimposition.

FIG. 3 is a schematic view of a conventional display apparatus for reducing laser speckles.

A laser source 146 emits laser lights 172, which are focused onto an optical modulator 150 through an optical illumination device 148 including a divergent lens 174, collimation lens 176, and a cylindrical lens 187.

Lights modulated by the optical modulator 150 are projected onto a screen 164 via a Schlieren optical device 152 including first and second release lenses 182 and 184, and a Schlieren stop 180, a diffuser 154 formed in a two dimensional rectangular array and generating a phase variation through a multiple of scans, and a projection device 156 including a projection lens 186 and a scanning mirror 188.

Here, during the multiple of scans, the diffuser 154, which has a two dimensional rectangular array corresponding to the N uncorrelated speckle patterns for generating the phase variation, reduces the speckles. However, the diffuser 154 should be included separately in a conventional display apparatus 142, and also, needs an intermediate image plane, increasing the volume of the conventional display apparatus 142 and complicating the structure. In addition, it is undesirable to apply this diffuser 154 to a small size display apparatus such as a small size projector.

### SUMMARY

Accordingly, the present invention provides an optical modulator and an optical modulator module, in which a phase manipulating pattern for reducing laser speckles is integrated with the optical modulator or the optical modulator module, so that there is no volume increase.

Also, the present invention provides an optical modulator and an optical modulator module, capable of keeping the image quality from being degraded by reducing laser speckles.

The present invention provides an optical modulator and an optical modulator module, applicable to a small size optical system such as a mobile optical system.

One aspect of the invention provides an optical modulator module comprising an optical modulator receiving and modulating incident lights, and outputting modulated lights as output lights; and a transparent substrate that is placed on the optical modulator, allowing the incident lights and the output lights to transmit, and that has a phase manipulating pattern formed on an area of a surface of the transparent substrate.

Here, the phase manipulating pattern is formed on an area of a surface of the transparent substrate where the incident lights or the output lights pass.

The incident lights are laser lights.

The phase manipulating pattern reduces a laser speckle generated by the laser lights.

The phase manipulating pattern creates phase variation of 0 radian and phase variation of π radian.

The phase manipulating pattern has a depressed or embossed pattern, and has a depth or height of a Barker code sequence pattern.

The depth or height satisfies the following formula: h=λ/2(n₀−1) whereas, λ is a wavelength of light, and n₀ is a refractive index of the transparent substrate.

Another aspect of the present invention provides an optical modulator comprising a substrate, an insulation layer placed on the substrate, a structure layer of which a center portion is spaced apart from the insulation layer, on a surface of which is formed an upper mirror, and on the center portion of which is formed a first phase manipulating pattern, and piezoelectric elements formed on both ends of the structure layer and allowing a center portion of the structure layer to bend upward and downward.

Here, one or more slits are formed lengthwise in the center portion of the structure layer, and on the insulation layer are formed a lower mirror and a second phase manipulating pattern below the first phase manipulating pattern.

The first phase manipulating pattern reduces a laser speckle generated by laser lights.

The first phase manipulating pattern creates phase variation of phase variation of 0 radian and phase variation of π radian.

The first phase manipulating pattern is formed with a depressed or embossed pattern, and has a depth or a height of a Barker code sequence pattern.

The depth or the height is a quarter of a wavelength of a light.

The second phase manipulating pattern reduces a laser speckle generated by laser lights.

The second phase manipulating pattern creates phase variation of 0 radian and phase variation of π radian.

The second phase manipulating pattern is formed with a depressed or embossed pattern, and has a depth or a height of a Barker code sequence pattern.

The depth or the height is a quarter of a wavelength of a light.

The first and second phase manipulating patterns have the same shape.

Additional aspects and advantages of the present general inventive concept will be set forth in part in the description which follows, and in part will be obvious from the description, or may be learned by practice of the general inventive concept.

### DESCRIPTION OF THE DRAWINGS

These and other features, aspects, and advantages of the present invention will become better understood with regard to the following description, appended claims, and accompanying drawings where:

FIG. 1 illustrates a human eye viewing a diffusion surface;

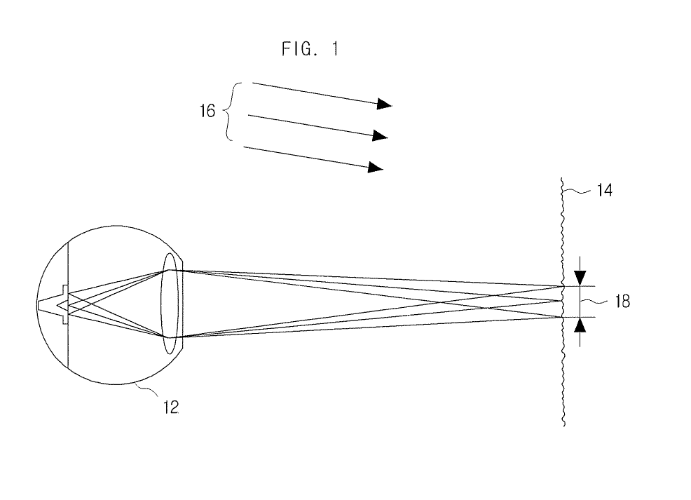

FIG. 2 illustrates a photo of speckles where spots of various brightness are formed in a granular pattern;

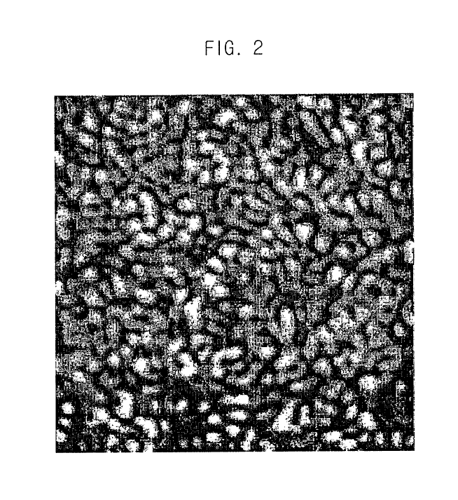

FIG. 3 is a schematic plan view of a conventional display apparatus for reducing laser speckles;

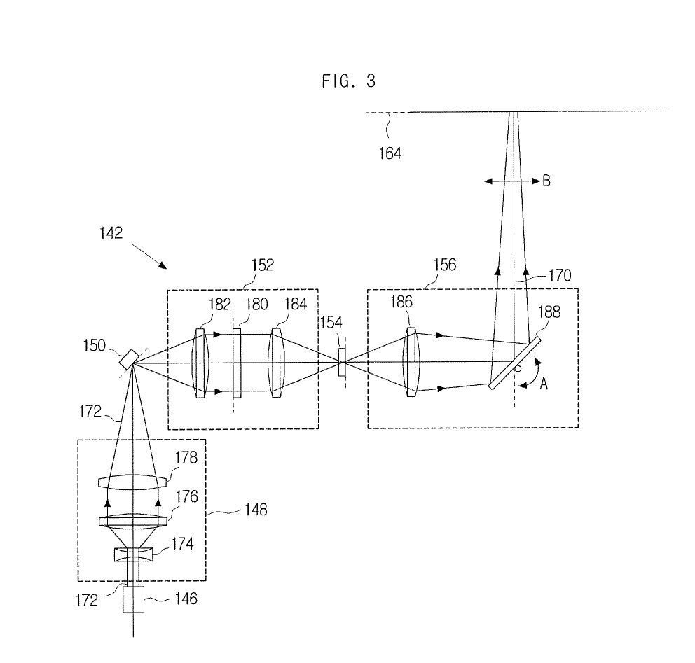

FIG. 4 illustrates a plan view of a display apparatus according to an embodiment of the present invention;

FIG. 5 illustrates a side view of a display apparatus developed along the optical axis of FIG. 4.

FIG. 6 is a perspective view showing an optical modulator included in a display apparatus according to an embodiment of the present invention;

FIG. 7 is a cross sectional view showing an optical modulator module having a phase manipulating pattern formed on a transparent substrate in accordance with an embodiment of the present invention;

FIG. 8 shows an example of Barker code sequence pattern;

FIG. 9 is a perspective view of an optical modulator having a phase manipulating pattern according to another embodiment of the present invention.

### DETAILED DESCRIPTION

Hereinafter, embodiments of the invention will be described in more detail with reference to the accompanying drawings. In the description with reference to the accompanying drawings, those components are rendered the same reference number that are the same or are in correspondence regardless of the figure number, and redundant explanations are omitted.

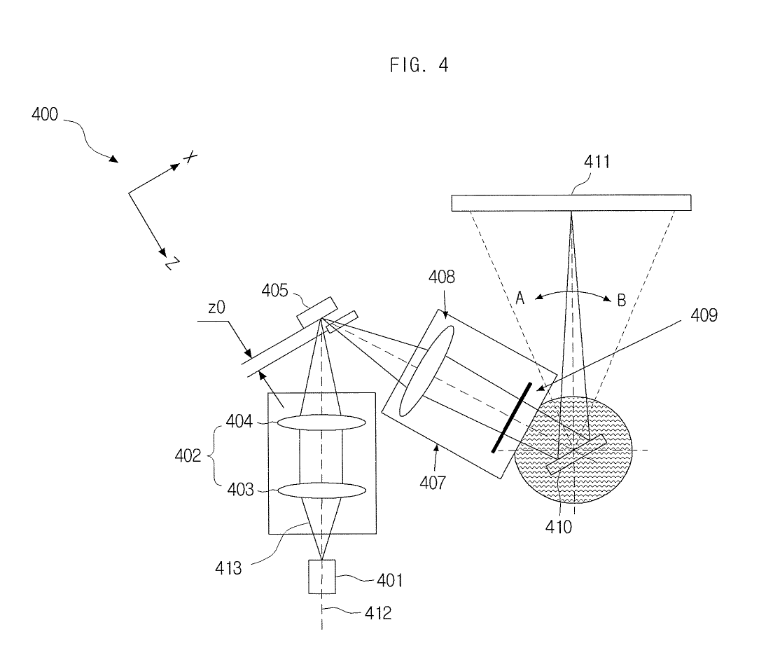

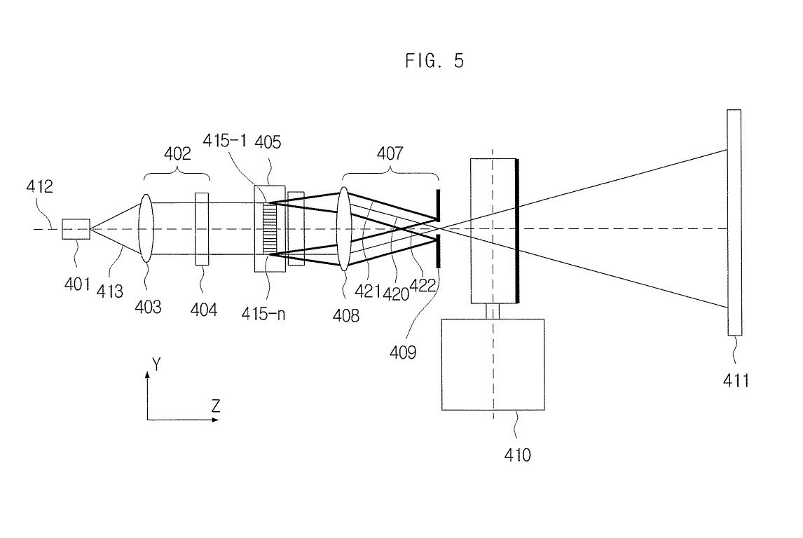

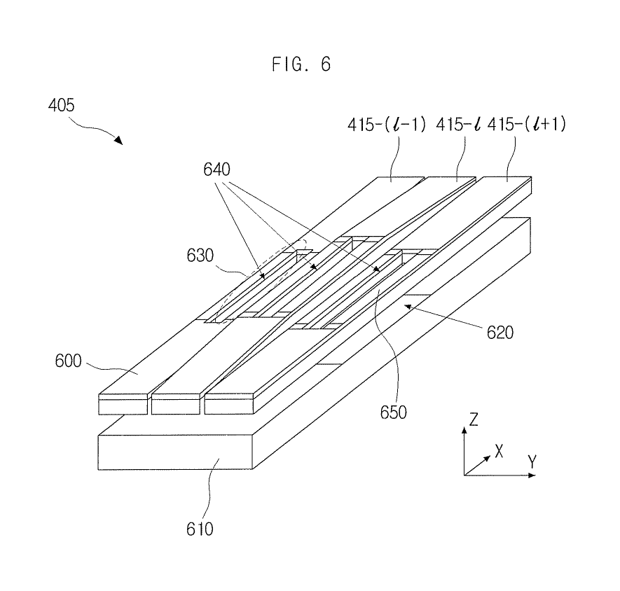

FIG. 4 is a plan view of a display apparatus according to an embodiment of the present invention, FIG. 5 is a side view of the display apparatus developed along the optical axis of FIG. 4, and FIG. 6 is a perspective view of an optical modulator included in a display apparatus in accordance with an embodiment of the present invention.

A display apparatus 400 includes a light source 401, an illumination system 402, an optical modulator 405, a projection system 407, and a scanning mirror 410. Here, the optical illumination system 402 and the projection system 407 are typical constituents in a conventional display apparatus.

The light source 401 emits lights, which pass through the illumination system 402 and reaches the optical modulator 405 along an optical axis 412. Since the present invention aims to reduce laser speckles by employing the coherent characteristic of laser lights, the light source 401 may be a laser source or a laser diode.

The illumination system 402 includes a condenser lens 403 condensing lights 413 emitted from the light source 401 to be parallel with the optical axis 412, and a cylindrical lens 404 concentrating the lights 413, which are condensed by the condenser lens 403, onto mirrors of the optical modulator 405. Although now shown herein, it is obvious to those skilled in the art that the lights 413 can be delivered to the cylindrical lens 404 through a divergent lens and a collimation lens instead of the condenser lens 403.

The illumination system 402 condenses the lights 413 from the light source 401 to be parallel with Y axis of FIG. 5 and also perpendicular to Z axis of FIG. 5, thereby allowing the lights 413 to be incident on the optical modulator 405 in a form of one dimension. Here, the lights 413 have an incident angle that allows reflected lights and diffracted lights to reach a Schlieren stop 409 of the projection system 407.

It is obvious that other optical systems can be used to emit the incident lights 413 to the optical modulator 405, and that the lenses used in the present invention can be a complex lens or reflective optical element as well as a lens with a single element.

In the optical modulator 405, a plurality of ribbons (415-1, . . . , 415-n, n is a natural number) are linearly arranged along a focus line (herein, Y axis in FIG. 5) of the cylindrical lens 404. The optical modulator 405 drives the ribbons (415-1, . . . , 415-n) upward and downward (herein, the direction of Z axis in FIG. 6) in accordance with electrical signals of a driving circuit (not shown in the accompanying drawings) for the optical modulator 405, thereby modulating the incident lights.

Below here, the optical modulator 405 will be described with reference to FIG. 6.

The optical modulator 405 includes an insulation layer 610 placed on a substrate (not shown), a structure layer 600 of which center portion is spaced apart from the insulation layer 610, and piezoelectric elements (not shown) formed on both sides of the structure layer 600 and allowing the center portion 630 of the structure layer 600 to bend up and down. On the center portion 630 of the structure layer 600 are formed an upper mirror 650 having a reflective characteristic. The structure layer 600 and the upper mirror 650 are collectively referred to as a ribbon 415, since they form an elongated shape.

In case that no slit is formed in the center portion 630 of the ribbon 415, more than one ribbons 415 are responsible for one pixel. The plurality of ribbons 415 bend up and down in accordance with a voltage applied to the piezoelectric elements (varied in accordance with electrical signals of a driving circuit of the optical modulator).

For example, when a first voltage is applied to even numbered ribbons, which normally remain at the same height with odd numbered ribbons, the even numbered ribbons bend upward or downward. At this time, a pathlength difference occurs between first reflected lights reflected from the even numbered ribbons and second reflected lights reflected from the odd numbered ribbons, thereby creating a diffraction (interference). By using this, the light intensity can be modulated and thus the gray scale of each pixel of an image can be represented.

On the other hand, in the case that the center portion 630 of the ribbon 415 has one or more slits 640 (as shown in FIG. 6), each ribbon 415 is responsible for one pixel. The slit 640 may be a rectangular hole elongated along a length direction of the ribbon 415 (the direction of X axis shown in FIG. 6).

Here, lower mirrors 620 having a reflective characteristic should be formed on the top surface of the insulation layer 610. The ribbons 415 are bent up and down in accordance with a voltage applied to the piezoelectric elements, by which the gap between the upper mirror 650 on the ribbon 415 and the lower mirror 620 on the insulation layer 610 can be adjusted. Diffraction (interference) occurs due to the pathlength difference between third reflected lights reflected from the upper mirror 650 and fourth reflected lights reflected from the lower mirror 620.

Regardless of whether or not the slit 640 is formed in the ribbon 415, the grayscale of one pixel is represented thanks to the pathlength difference between the reflected lights, and each reflected light generates a diffracted light (421, 422) such as +1^{st} diffracted light (D+1) and −1^{st} diffracted light (D−1), as well as reflected light 420 (0^{th} diffracted light).

As will be seen in the description below, the Schlieren stop 409 in the projection system 407 allows the reflected lights 420 to pass therethrough but stops the diffracted lights 421, 422 from progressing.

However, it is obvious that the Schlieren stop 409 can stop the reflected lights, but allow the diffracted lights 421, 422 to pass therethrough. It is also obvious that electrostatic elements can be used to drive the ribbon 415 upward and downward.

The optical modulator 405 modulates incident lights and outputs the modulated lights as output lights, such that one or more ribbons 415 represent the grayscale of one pixel of an image. As described above, the output lights include reflected lights 420 and diffracted lights 421, 422. The optical modulator 405 represents one dimensional linear image by means of the plurality of ribbons 415 arranged parallel along the direction of the Y axis illustrated in FIGS. 5 and 6.

At a particular point, the optical modulator 405 represents the grayscale of one dimensional linear image (in a vertical or horizontal direction) constituting two dimensional image, and the scanning mirror 410 displays the one dimensional linear image on a particular position of the screen 411. The optical modulator 405 modulates a plurality of one dimensional linear images according to a scanning frequency, and then the scanning mirror 410 scans in a predetermined direction (bi-directionally or unidirectionally) to display them as a two dimensional image.

The outputted light 420, 421, 422 from the optical modulator 405 is sent to the scanning mirror 410 via the projection system 407. The projection system 407 includes a projection lens 408 and the Schrielen stop 409. The projection lens 408 extends the outputted light 420, 421, 422, which is a one dimensional linear image, into a two dimensional spatial image (it consists of a one dimensional image extended laterally), which is finally projected on the screen 411 as one dimensional linear image by the scanning mirror 410. The Schrielen stop 409 allows either the reflected lights 420 or the diffracted lights 421, 422 to pass therethrough.

A galvano mirror returns to the original position with a first scanning movement A, and projects with a second scanning movement B the outputted one dimensional linear image onto the screen 411. Otherwise, the scanning mirror 410 can operate conversely. A polygon mirror (not shown), which rotates in one direction to project the outputted light onto the screen 411, can be used instead of the galvano mirror. Hereinafter, the polygon mirror and the galvano mirror are collectively referred to as the scanning mirror 410.

In the present invention, a phase manipulating part for reducing laser speckles is located between the optical modulator 405 and the projection system 407. Hereinafter, an apparatus and a method reducing laser speckles through phase manipulation will be described.

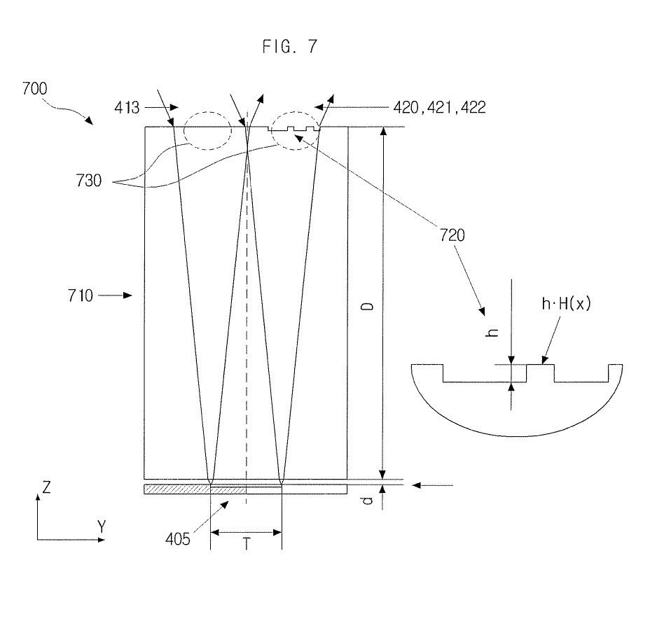

FIG. 7 is a cross sectional view of an optical modulator having a phase manipulating pattern formed on a transparent substrate in accordance with an embodiment of the present invention.

The optical modulator module 700 includes an optical modulator 405 and a transparent substrate 710. The transparent substrate 710 is placed on a surface of the optical modulator 405 involved in optical modulation, and allows incident lights 413 and outputted lights 420, 421, 422 to pass therethrough. Since the optical modulator 405 is a MEMS (Micro Electro Mechanical Systems) that performs mechanical movements according to minute electricity (voltage, current, etc.), the optical modulator 405 is modularized in order to be kept from external factors such as air.

Also, in order to minimize the size of the module itself, the ribbons 415, performing mechanical movements, are sealed by using the transparent substrate 710.

The transparent substrate 710 is formed of a material transmitting more than 99% of lights (e.g., glass).

Referring to FIG. 7, the phase manipulating pattern 720 is formed on an area of the surface of the transparent substrate 710 where the outputted lights 420, 421, 422 pass.

As shown in FIG. 7, the phase manipulating pattern 720 can be formed with a depressed pattern, thereby having two different depths (0 or h). Otherwise, the phasing manipulating pattern 720 can be formed with an embossed pattern, also having two different heights (0 or h). Due to the depth or height difference, a phase variation occurs between the outputted lights 420, 421, 422 by 0 or π radian.

It is undesirable that the phase manipulating pattern 720 is formed on an area of the top surface 730 of the transparent substrate 710 where the incident lights 413 pass, since it can deteriorate the contrast ration of the display apparatus 400.

The distance Z₀ (d+D) from the top surface of the optical modulator 405 to the top surface of the phase manipulating pattern 720, should meet the following Formula 1.

$${z}_{0} \leq \frac{{T}^{2}}{λ} + D \frac{{n}_{0} - 1}{{n}_{0}} \qquad [ Formula 1 ]$$

while z₀>D

D, the thickness of the transparent substrate 710, satisfies the following requirement:

$$D \leq {n}_{0} ( \frac{{T}^{2}}{λ} - d )$$

where d is a gap between the top surface of the optical modulator 405 and the bottom surface of transparent substrate 710.

Here, T represents beam width, or the size of a single pixel in X direction, and λ is a wavelength of light.

In the case of d<<D, d can be disregarded, so that the requirement for the thickness of the transparent substrate 710 is as follows:

$$D \leq {n}_{0} \frac{{T}^{2}}{λ}$$

The phase manipulating pattern 720 follows a Barker code sequence pattern. The Barker code sequence pattern is an uncorrelated sequence pattern of which maximum length is 13, and generated by a Barker code such as Formula 2 and Formula 3.
B=[1 1 1 1 1 −1 −1 1 1 −1 1 −1 1] [Formula 2]

$$H ( x ) = {\sum }_{i = 0}^{N - 1} {B}_{i} \cdot rect ( \frac{N}{T} x - i ) \qquad [ Formula 3 ]$$

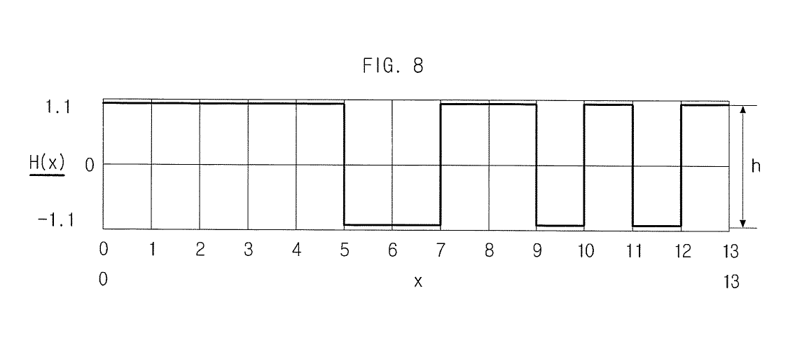

Here, rect(x−i) is 1 when x is between i and i+1, and 0 when x is not between i and i+1. And N is Barker code length (N=13). FIG. 8 shows a Barker code sequence pattern obtained from Formula 2 and Formula 3.

In Formula 2, the plus (+) sign means a phase variation of 0 radian, which will be called a first phase variation, and the minus (−) sign means a phase variation of π radian, which will be called a second phase variation. Otherwise, it may be the opposite. The depth (or height) in the Barker code sequence pattern should satisfy the following Formula 4.
h=λ/2(n₀−1) [Formula 4]

Here, n₀ is the refractive index of the transparent substrate 720.

Now profile 720 presented at FIG. 7 will be: h*H(x).

The pattern 720 described by Formula 3 should have total length along X direction equal to single pixel size, or beam width T at modulator 405. This pattern may be periodically repeated along X direction in order to avoid miss-coincidence of beam and pattern 720.

The characteristic feature of pattern by Formula 3 is that its autocorrelation function has narrow peak (approximately equal to single bit, or pitch T/N) and low side lobe level. That means that after shifting this pattern along X direction at a distance Δx equal or more than single pitch (Δx≦T/N) it become non correlated to previous one.

By employing the Barker code sequence pattern as shown in FIG. 8 as the phase manipulating pattern 720, uncorrelated spot patterns can be superimposed, reducing the laser spots. In this example, since the maximum length of the Barker code sequence is 13, the greatest value of the spot reduction factor can be \sqrt{13}

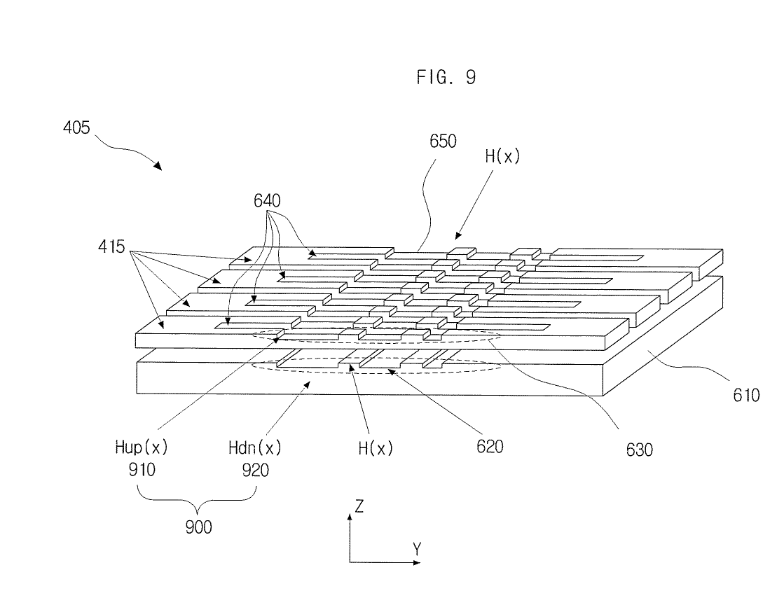

FIG. 9 is a perspective view of an optical modulator having a phase manipulating pattern in accordance with another embodiment of the present invention.

The slit 640 is formed on each ribbon 415 of the optical modulator 405. A first phase manipulating pattern (Hup(x)) 910 is formed on a center portion 630 of each ribbon 415, namely, on the upper mirror 650. A second phase manipulating pattern (Hdn(x)) 920 is formed on the lower mirror 620 of the insulation layer 610.

It is recommendable that the first phase manipulating pattern 910 and the second phase manipulating pattern 920 is the same (Hup(x)=Hdn(x)), and they may have the Barker code sequence pattern (H(x)) as shown in FIG. 8. Furthermore, the first phase manipulating pattern 910 and the second phase manipulating pattern 920 may have a depressed pattern (as shown in FIG. 9) or an embossed pattern.

When no slit is formed in each ribbon 415, only on the upper mirror 650 of each mirror 415 is formed the first phase manipulating pattern 910. In such a case, more than two ribbons 415 participate in representing the grayscale of a single pixel.

In both cases, the phase manipulating pattern 900 is formed on the surface of the ribbon 405 of the optical modulator 405 (this means, z₀=0), so that Formula 1 is always satisfied. Here, the depth (or the height) h of the first phase manipulating pattern 910 and/or the second manipulating pattern 920 is λ/4.

According to the above description, a phase manipulating pattern is formed on the transparent substrate 710 of the optical modulator module or on the surface of the ribbon 415 of the optical modulator. The outputted lights, which are one dimensional linear lights, are spread out as a two dimensional spatial light in the projection system 407, condensed, by the projection lens 407, into a single one dimensional linear light, and directed to the screen 411 by the scanning mirror 410.

Scanning light beam on the screen moves to human eye resolution area. It has phase manipulated profile according to Formula 3. If all design is correct then beam width corresponds to human eye resolution area size. Each time when beam shifts at one pitch distance M*T/N (M—magnification on the screen) it creates new non correlated random intensity in human eye. Total number of these non-correlated intensities is equal to N. As a result, the intensity level is averaged an N number of times in the human eye. This process repeats over whole screen and total speckle contrast decreases by \sqrt{N} times.

While the invention has been described with reference to the disclosed embodiments, it is to be appreciated that those skilled in the art can change or modify the embodiments without departing from the scope and spirit of the invention or its equivalents as stated below in the claims.

What is claimed is:

1. An optical modulator module comprising:
an optical modulator receiving and modulating incident lights, and outputting modulated lights as output lights; and
a transparent substrate that is placed on the optical modulator, allowing the incident lights and the output lights to transmit, and that has a phase manipulating pattern formed on an area of a surface of the transparent substrate

2. The optical modulator module of claim 1, wherein the phase manipulating pattern is formed on an area of a surface of the transparent substrate where the incident lights or the output lights pass.

3. The optical modulator module of claim 1, wherein the incident lights are laser lights.

4. The optical modulator module of claim 3, wherein the phase manipulating pattern reduces a laser speckle generated by the laser lights.

5. The optical modulator module of claim 1, wherein the phase manipulating pattern creates phase variation of 0 radian and phase variation of π radian.

6. The optical modulator module of claim 5, wherein the phase manipulating pattern has a depressed or embossed pattern, and has a depth or height of a Barker code sequence pattern.

7. The optical modulator module of claim 6, wherein the depth or height satisfies the following formula:
h=λ/(n₀−1); whereas, λ is a wavelength of light, and n₀ is a refractive index of the transparent substrate.

8. An optical modulator comprising:
a substrate;
an insulation layer placed on the substrate;
a structure layer of which a center portion is spaced apart from the insulation layer, on a surface of which is formed an upper mirror, and on the center portion of which is formed a first phase manipulating pattern; and
piezoelectric elements formed on both ends of the structure layer and allowing a center portion of the structure layer to bend upward and downward.

9. The optical modulator of claim 8, wherein one or more slits are formed lengthwise in the center portion of the structure layer, and on the insulation layer are formed a lower mirror and a second phase manipulating pattern below the first phase manipulating pattern.

10. The optical modulator of claim 8, wherein the first phase manipulating pattern reduces a laser speckle generated by laser lights.

11. The optical modulator of claim 10, wherein the first phase manipulating pattern creates phase variation of phase variation of 0 radian and phase variation of π radian.

12. The optical modulator of claim 11, wherein the first phase manipulating pattern is formed with a depressed or embossed pattern, and has a depth or a height of a Barker code sequence pattern.

13. The optical modulator of claim 12, wherein the depth or the height is a quarter of a wavelength of a light.

14. The optical modulator of claim 9, wherein the second phase manipulating pattern reduces a laser speckle generated by laser lights.

15. The optical modulator of claim 14, wherein the second phase manipulating pattern creates phase variation of 0 radian and phase variation of π radian.

16. The optical modulator of claim 14, wherein the second phase manipulating pattern is formed with a depressed or embossed pattern, and has a depth or a height of a Barker code sequence pattern.

17. The optical modulator of claim 16, wherein the depth or the height is a quarter of a wavelength of a light.

18. The optical modulator of claim 9, wherein the first and second phase manipulating patterns have the same shape.
